(19) United States
(12) Patent Application Publication
(10) Pub. No.: US 2014/0126484 A1
(43) Pub. Date: May 8, 2014

(54) PROCESSING OVERLAPPING EPDCCH RESOURCE SETS

(71) Applicant: QUALCOMM Incorporated, San Diego, CA (US)

(72) Inventors: Wanshi CHEN, San Diego, CA (US); Tao LUO, San Diego, CA (US); Peter GAAL, San Diego, CA (US); Hao XU, San Diego, CA (US); Yongbin WEI, San Diego, CA (US)

(21) Appl. No.: 13/958,375

(22) Filed: Aug. 2, 2013

Related U.S. Application Data
(60) Provisional application No. 61/722,041, filed on Nov. 2, 2012.

(51) Int. Cl. H04W 72/04

(52) U.S. Cl. CPC H04W 72/0466
USPC 370/329

(57) ABSTRACT

A method of wireless communication is presented. The method includes determining whether decoding candidates for enhanced control channel resource sets overlap. The method further includes determining uplink resources based on a predefined rule when the decoding candidates overlap.

### CROSS-REFERENCE TO RELATED APPLICATION

This application claims the benefit under 35 U.S.C. §119(e) to U.S. Provisional Patent Application No. 61/722,041 entitled “HANDLING OVERLAPPED EPDCCH RESOURCE,” filed on Nov. 2, 2012, the disclosure of which is expressly incorporated by reference herein in its entirety.

### BACKGROUND

1. Field

Aspects of the present disclosure relate generally to wireless communication systems, and more particularly to processing overlapping resource sets for enhanced physical downlink control channels (EPDCCHs).

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### SUMMARY

In one aspect of the present disclosure, a method of wireless communication is disclosed. The method includes determining whether decoding candidates for enhanced control channel resource sets overlap. The method further includes determining uplink resources based on a predefined rule when the decoding candidates overlap.

Another aspect of the present disclosure is directed to an apparatus including means for determining whether decoding candidates for enhanced control channel resource sets overlap. The apparatus further includes means for determining uplink resources based on a predefined rule when the decoding candidates overlap.

In another aspect, a computer program product for wireless communications in a wireless network having a non-transitory computer-readable medium is disclosed. The computer readable medium has non-transitory program code recorded thereon which, when executed by the processor(s), causes the processor(s) to perform operations of determining whether decoding candidates for enhanced control channel resource sets overlap. The program code also causes the processor(s) to determine uplink resources based on a predefined rule when the decoding candidates overlap.

Another aspect discloses wireless communication having a memory and at least one processor coupled to the memory. The processor(s) is configured to determine whether decoding candidates for one or more enhanced control channel resource sets overlap. The processor(s) is further configured to determine uplink resources based on a predefined rule when the decoding candidates overlap.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of an access network.

FIG. 3 is a diagram illustrating an example of a downk frame structure in LTE.

FIG. 4 is a diagram illustrating an example of an uplink frame structure in LTE.

FIG. 5 is a diagram illustrating an example of a radio protocol architecture for the user and control plane.

FIG. 6 is a diagram illustrating an example of an evolved Node B and user equipment in an access network.

FIG. 7 is a diagram illustrating various EPDCCH structures.

FIG. 8 is a block diagram illustrating different modules/means/components in an exemplary apparatus.

FIGS. 9-10 are block diagrams illustrating methods for determining uplink resources according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Aspects of the telecommunication systems are presented with reference to various apparatus and methods. These apparatus and methods are described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a non-transitory computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

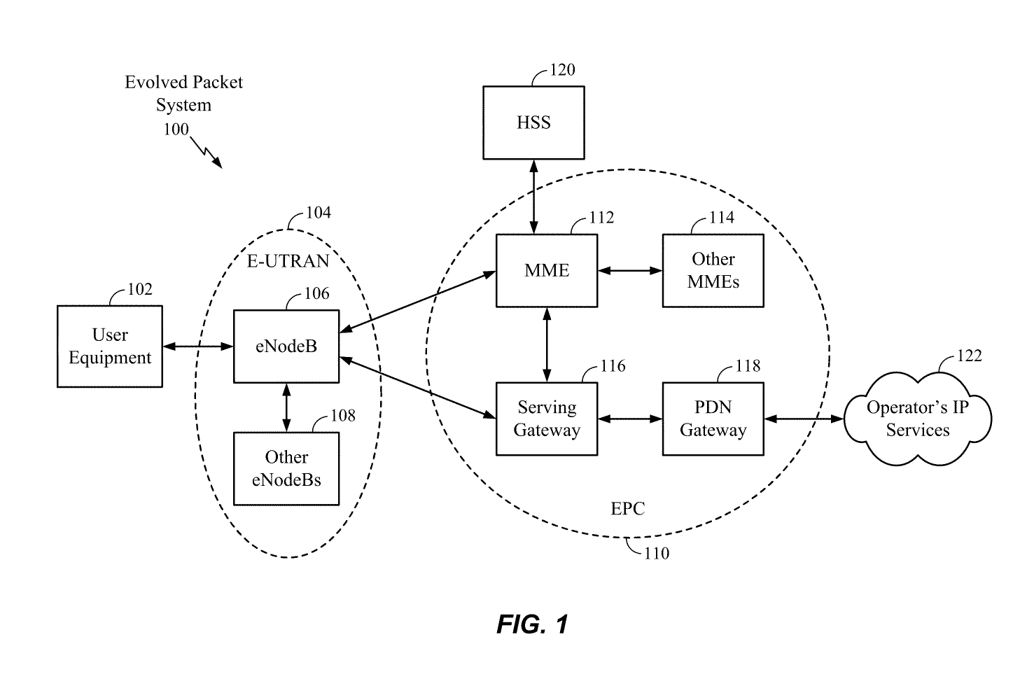

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

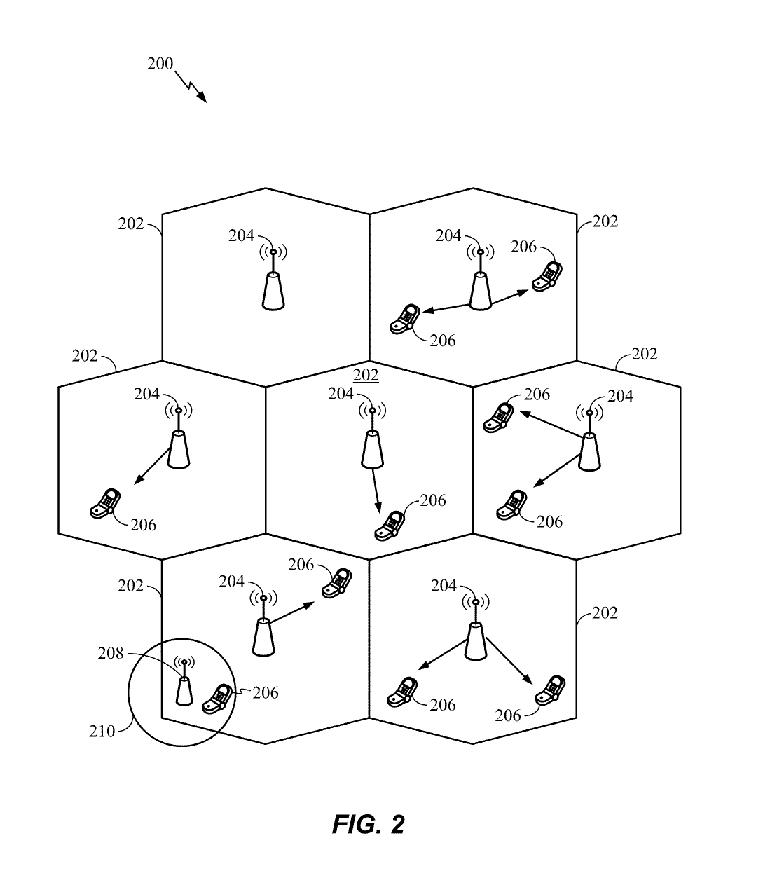

FIG. 2 is a diagram illustrating an example of an access network 200 in an LTE network architecture. In this example, the access network 200 is divided into a number of cellular regions (cells) 202. One or more lower power class eNodeBs 208 may have cellular regions 210 that overlap with one or more of the cells 202. A lower power class eNodeB 208 may be a remote radio head (RRH), a femto cell (e.g., home eNodeB (HeNB)), a pico cell, or a micro cell. The macro eNodeBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNodeBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the downk and SC-FDMA is used on the uplink to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNodeBs 204 may have multiple antennas supporting MIMO technology. The use of MIMO technology enables the eNodeBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the downk. The spatially precoded data streams arrive at the UE(s) 206 with different spatial signatures, which enables each of the UE(s) 206 to recover the one or more data streams destined for that UE 206. On the uplink, each UE 206 transmits a spatially precoded data stream, which enables the eNodeB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downk. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PAPR).

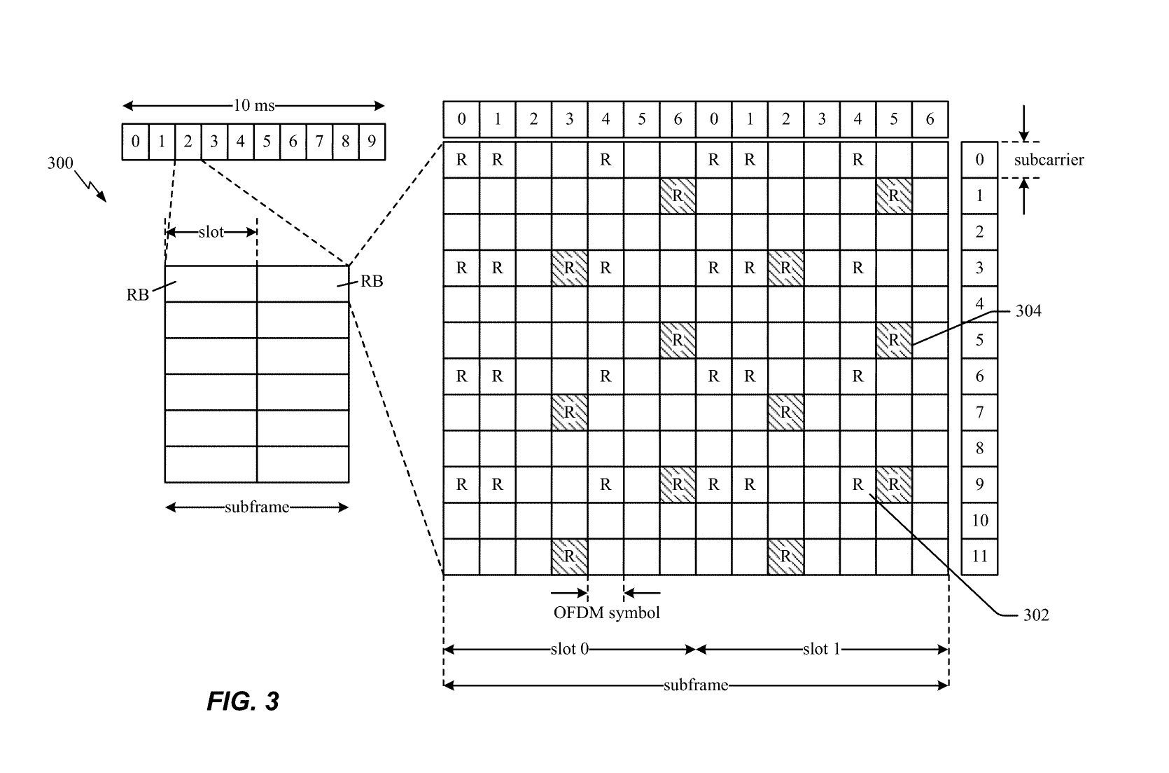

FIG. 3 is a diagram 300 illustrating an example of a downk frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include downk reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical downk shared channel (PDSCH) is mapped. The number of bits carried by each resource element depends on the modulation scheme. Thus, the more resource blocks that a UE receives and the higher the modulation scheme, the higher the data rate for the UE.

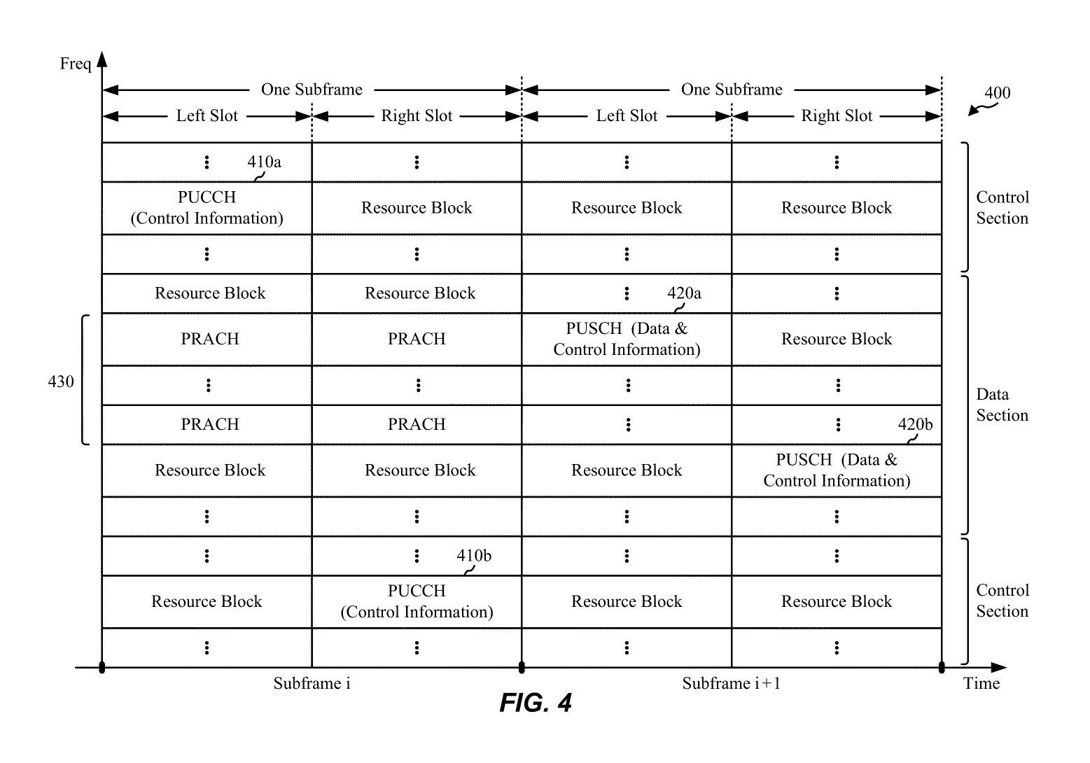

FIG. 4 is a diagram 400 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 410a, 410b in the control section to transmit control information to an eNodeB. The UE may also be assigned resource blocks 420a, 420b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 430. The PRACH 430 carries a random sequence. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

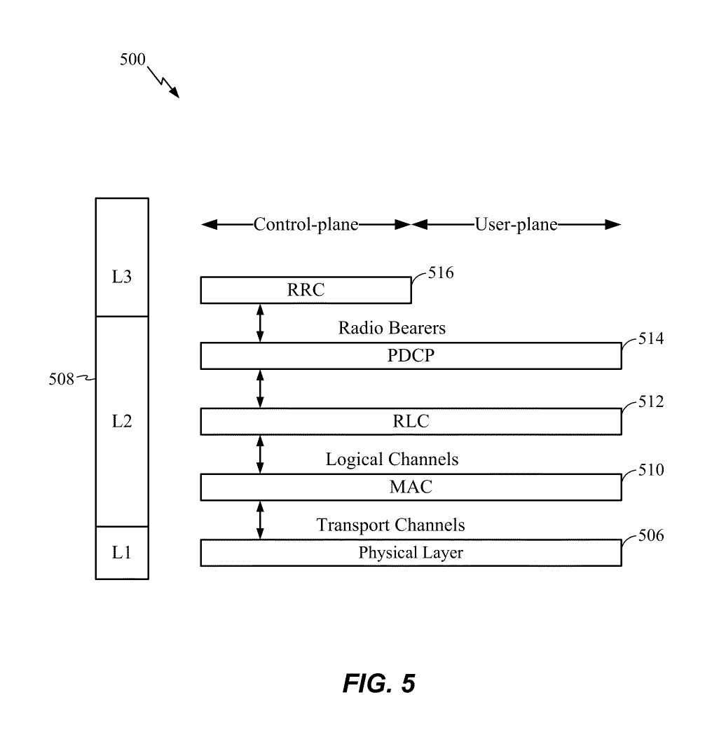

FIG. 5 is a diagram 500 illustrating an example of a radio protocol architecture for the user and control planes in LTE. The radio protocol architecture for the UE and the eNodeB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNodeB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNodeB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNodeBs. The RLC sublayer 512 provides segmentation and reassembly of upper layer data packets, retransmission of lost data packets, and reordering of data packets to compensate for out-of-order reception due to hybrid automatic repeat request (HARM). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNodeB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNodeB and the UE.

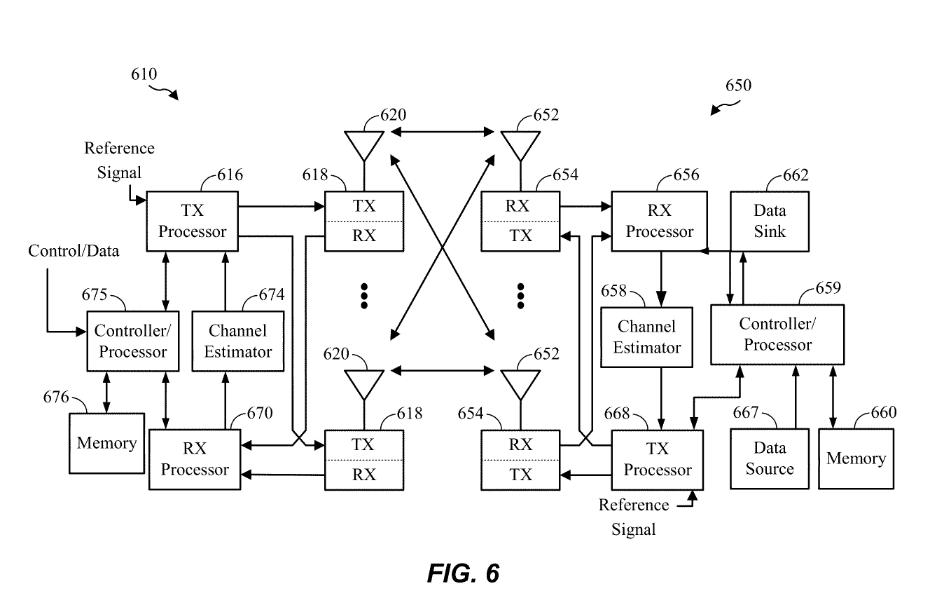

FIG. 6 is a block diagram of an eNodeB 610 in communication with a UE 650 in an access network. In the downk, upper layer packets from the core network are provided to a controller/processor 675. The controller/processor 675 implements the functionality of the L2 layer. In the downk, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNodeB 610. These soft decisions may be based on channel estimates computed by the channel estimator 658. The soft decisions are then decoded and deinterleaved to recover the data and control signals that were originally transmitted by the eNodeB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the uplink, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the uplink, a data source 667 is used to provide upper layer packets to the controller/processor 659. The data source 667 represents all protocol layers above the L2 layer. Similar to the functionality described in connection with the downk transmission by the eNodeB 610, the controller/processor 659 implements the L2 layer for the user plane and the control plane by providing header compression, ciphering, packet segmentation and reordering, and multiplexing between logical and transport channels based on radio resource allocations by the eNodeB 610. The controller/processor 659 is also responsible for HARQ operations, retransmission of lost packets, and signaling to the eNodeB 610.

Channel estimates derived by a channel estimator 658 from a reference signal or feedback transmitted by the eNodeB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The uplink transmission is processed at the eNodeB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the uplink, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

### Processing Overlapping EPDCCH Resource Sets

In LTE Releases 8, 9, and 10, a control channel, such as a physical downk control channel (PDCCH), is located in the first several symbols of a subframe. The control channel is fully distributed in the entire system bandwidth. Furthermore, the control channel is time multiplexed (TDMed) with a shared channel, such as a physical downk shared channel (PDSCH). Thus, a subframe is divided into a control region and a data region.

In LTE Release 11, an enhanced control channel, such as the enhanced PDCCH (EPDCCH), is introduced. In contrast to a typical control channel that occupies the first several control symbols in a subframe, the enhanced control channel may occupy the data region, similar to the shared channel (PDSCH). The enhanced control channel may increase control channel capacity, support frequency-domain inter-cell interference coordination (ICIC), improve spatial reuse of control channel resources, support beamforming and/or diversity, operate on the new carrier type and in multimedia broadcast over single frequency network (MBSFN) subframes, and coexist on the same carrier as conventional UEs.

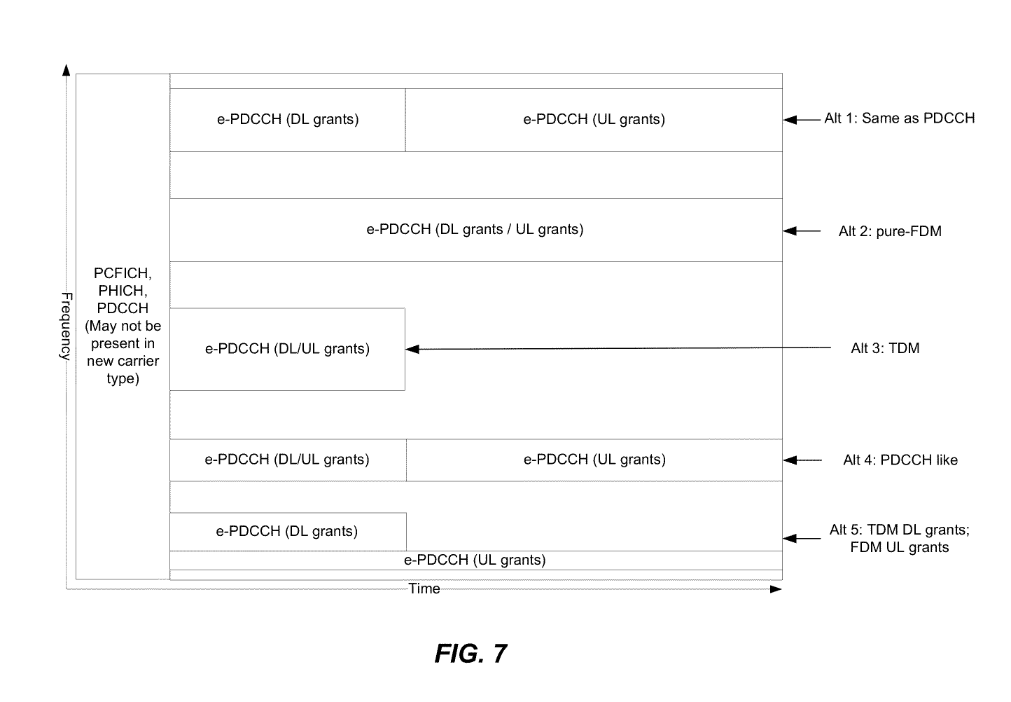

FIG. 7 illustrates various enhanced control channel structures. For example, the enhanced control channel structure may be the same as the typical control channel structure. Alternately, the enhanced control channel may be pure-FDM. Optionally, in an alternate structure, the enhanced control channel structure is all TDM. Alternately, the enhanced control channel is similar, but not the same as the typical control channel. In another alternate structure, the enhanced control channel may combine TDM and FDM.

LTE Release 11 supports both localized and distributed transmissions of an enhanced control channel. Furthermore, LTE Release 11 supports an enhanced control channel demodulation reference signal (DM-RS). The enhanced control channel demodulation may use antenna ports 107, 108, 109, and 110. A shared channel, such as the PDSCH, uses antenna ports 7-14.

The enhanced control channel is based on frequency division multiplexing (FDM). That is, the enhanced control channel spans both the first and second slots. In some cases, there may be a restriction on the maximum number of transport channel (TrCH) bits receivable in a transmission time interval (TTI). A shared channel and an enhanced control channel may not be multiplexed within a physical resource block (PRB) pair.

The presence of the enhanced control channel may be subframe dependent. That is, the enhanced control channel may not be in all subframes. In subframes where a UE monitors an enhanced control channel UE specific search space (USS) on a given carrier, the UE may not monitor a conventional control channel UE specific search space on the same carrier. The UE may be configured to monitor either localized or distributed enhanced control channel candidates in a given subframe. Additionally, the UE may monitor a common search space (CSS) on the control channel. Alternatively, the UE may also monitor a common search space on an enhanced control channel if the UE determines that a common search space exists on the enhanced control channel. The UE may determine that the common search space exists on the enhanced control channel based on, for example, a carrier type or signaling.

The UE may also be configured to monitor both localized and distributed enhanced control channel candidates in a given subframe. In some cases, the total number of UE specific search space blind decodes on the carrier are not increased when the UE is configured to monitor both localized and distributed enhanced control channel candidates.

The subframes specified for the UE to monitor the enhanced control channel UE specific search space may be predetermined. In particular, the enhanced control channel may not be monitored by a UE for special subframe configurations 0 and 5 for normal cyclic prefix (CP), or special subframe configurations 0 and 4 for extended CP in a time-division duplex (TDD) system. In another configuration, higher layer signaling may configure a set of subframes for monitoring the enhanced control channel. In another configuration, a UE may determine whether to monitor the enhanced control channel in a subframe based on other implicit information.

As an example, a UE may monitor the enhanced control channel in a subframe if the subframe is a new carrier type subframe. As another example, a UE may monitor the enhanced control channel in a subframe based an indication in a broadcast message. When the UE determines it is not to monitor the enhanced control channel on specific subframes, the UE may monitor the common search space and/or the UE specific search space on the control channel pursuant to the LTE Release 10 specification.

In some cases, a UE may be configured with more than one enhanced control channel resource set. The number of enhanced control channel resource sets may be denoted as K. In one configuration, the UE is configured with two enhanced control channel resource sets (e.g., K=2) for enhanced control channel monitoring. An enhanced control channel resource set is defined as a group of N physical resource block (PRB) pairs. Each resource set may have a specific size (e.g., 2, 4 or 8 PRB pairs). Further, each resource set includes a set of enhanced control channel elements which make up the enhanced control channel search space. The UE may monitor a set of enhanced control channel candidates such that the UE attempts to decode each of the enhanced control channels in the set according to the monitored downk control information formats.

The total number of blind decoding attempts is independent from the number of configured enhanced control channel resource sets (K). Still, the total blind decoding attempts for a UE may be split into the number of configured enhanced control channel resource sets. Each enhanced control channel resource set may be configured for either a localized enhanced control channel or a distributed enhanced control channel. Resources may not be orthogonal. That is, physical resource block pairs of enhanced control channel resource sets with different logical enhanced control channel resource set indices may fully overlap, partially overlap, or not overlap at all.

In LTE Release 11, the enhanced control channel demodulation reference signal and the shared channel demodulation reference signal use the same scrambling sequence generator. At the start of each subframe, the scrambling sequence generator for the enhanced control channel DM-RS on ports 107-110 may be initialized with:

cᵢₙᵢₜ=(└nₛ/2┘+1)·(2X+1)·2¹⁶+n_{SCID} (1)

In equation (1), X is a virtual cell ID and is configured by UE-specific higher layer signaling. For the shared channel scrambling sequence, the scrambling ID (n_{SCID}) may be 0 or 1. Furthermore, in one configuration, for the enhanced control channel scrambling sequence, the value of the scrambling ID (n_{SCID}) is 2. For example, the value of the scrambling ID for the enhanced control channel (e.g., 2) may be different from the possible values available for the scrambling ID of the shared channel (e.g., 0 or 1). Accordingly, the enhanced control channel demodulation reference signal can be differentiated from the shared channel demodulation reference signal.

Typically, uplink feedback is specified in response to a downk transmission. Specific resources for the uplink feedback may be specified for the UE. For example, an ACK/NAK resource location is specified for a HARQ transmission in response to a scheduled enhanced control channel downlink transmission and/or a corresponding physical downk shared channel transmission, if any.

In one configuration, when determining uplink control channel resources, a lowest enhanced control channel element (ECCE) index of the corresponding enhanced control channel is a component of determining an uplink control channel resource. That is, the enhanced control channel element is a construction unit for the enhanced control channel search space. A UE may be configured with an initial semi-static uplink control channel resource offset for each enhanced control channel resource set. Alternatively, the specific enhanced control channel resource set offset may be broadcast to the UE. Thus, an enhanced control channel element may be separately indexed and may have an offset for each enhanced control channel resource set.

In some cases, the index and/or offset for an enhanced control channel element may be ambiguous. For example, two enhanced control channel resource sets may be configured for a UE. In this example, the two resource sets overlap such that a decoding candidate for a first enhanced control channel resource set is also a decoding candidate for the second enhanced control channel resource set. That is, the decoding candidates for the two enhanced control channel resource sets may overlap. As a result, a valid enhanced control channel candidate may be incorrectly treated as an ambiguous candidate while an ambiguous enhanced control channel candidate may be incorrectly treated as a valid candidate. Thus, such ambiguity may cause misalignment between a base station and UE and improper/unintended enhanced control channel operation. Moreover, in the present example, the two enhanced control channel resource sets may have the same scrambling initialization for the enhanced control channel DM-RS and the enhanced control channel data portion. That is, in equation (1), the value of X is the same for the both enhanced control channel resource sets.

In the aforementioned example, a UE may not be able to distinguish the overlapped decoding candidates associated with the two enhanced control channel resource sets under a same downk control information payload size. As previously discussed, the enhanced control channel element indexing is dependent on an enhanced control channel resource set. Thus, when the decoding candidates overlap, the UE may not properly determine the enhanced control channel element indexing. More specifically, the UE may not be able to determine the initial (or first) enhanced control channel element. Additionally, an uplink control channel offset is also dependent on an enhanced control channel resource set. Thus, when the decoding candidates overlap, the UE may not be able to determine the semi-static uplink control channel resource offset.

The inability to properly determine the initial enhanced control channel elements and/or the initial offset may result in the UE failing to properly determine the uplink resources, such as uplink control channel resources for ACK/NAK transmission, associated with the scheduled enhanced control channel transmissions. In one configuration, the scheduled enhanced control channel transmissions may include an enhanced control channel and a corresponding shared data channel. In this configuration, the scheduled enhanced control channel transmissions may also include an enhanced control channel without a corresponding shared data channel. For example, the scheduled enhanced control channel transmissions may be an enhanced control channel for semi-persistent scheduling (SPS).

According to an aspect of the present disclosure, a predetermined rule is specified so that the UE may determine the initial enhanced control channel elements and/or the initial offset. In one configuration, when the decoding candidates overlap, the decoding candidate is specified as the decoding candidate from the first resource set of the enhanced control channel resource sets. That is, in this configuration, when two enhanced control channel resource sets are specified, the initial (or first) enhanced control channel elements and/or the initial offset are determined based on the decoding candidate of the first enhanced control channel resource set and not the second enhanced control channel resource set.

More specifically, in the present configuration, when decoding candidates of two or more enhanced control channel resource sets having the same payload size (e.g., downk control information size) and being mapped to the same set of resource elements (REs) (e.g., they overlap), the initial control channel element is determined based on the decoding candidate of the first enhanced control channel resource set. Moreover, the index of the initial control channel element of the decoding candidate associated with the first enhanced control channel set is used to determine the uplink control channel resources for ACK/NAK transmissions.

Furthermore, in one configuration, each enhanced control channel set is denoted by a value (p), so that for two enhanced control channel sets (K=2), p is numbered from zero to K−1. That is, for the first enhanced control channel, p is equal to zero, and for the second enhanced control channel, p is equal to one. Accordingly, when the decoding candidates overlap, the predefined rule for selecting the decoding candidate based on the first enhanced control channel resource set may specify selecting the enhanced control channel set with p equal to zero. For example, the predefined rule may specify when two EPDCCH candidates of two enhanced control channel resource sets overlap and when the number of the first enhanced control channel element (ECCE) of the received EPDCCH candidate is used for determining uplink resources for ACK/NAK transmission, the number of the first ECCE may be determined based on the first enhanced control channel resource set (e.g., p=0).

In another configuration, the decoding candidate may be selected based on the set size, and/or whether the enhanced control channel resource sets are localized or distributed. In yet another configuration, the decoding candidate may be selected based on a priority of an enhanced control channel resource set. That is, enhanced control channel resource sets specified in a common search space are given higher priority in comparison to enhanced control channel resource sets specified in a UE-specific search space. The decoding candidate selection rules can operate separately or jointly with other decoding candidate selection rules.

In another aspect of the present disclosure, the ambiguity resulting from the overlapping resource assignments is treated as an error event. That is, the UE behavior is not specified. Thus, the eNodeB attempts to avoid overlapping resource assignments. Still, in some cases, resource assignments may overlap in specific scenarios. For example, if there is no ambiguity, error event processing will not be specified even when resource assignments overlap each other. In the present example, both enhanced control channel resource sets may have the same starting offset and/or enhanced control channel element indexing. That is, an error event is not declared when the UE can unambiguously determine resources for uplink transmissions.

According to yet another aspect, a physical (PHY) layer distinction is specified to distinguish the enhanced control channel resource sets. For example, the DM-RS scrambling initialization and/or data scrambling may be different for the two sets. In this example, the scrambling ID for each set (n_{SCID} from equation (1)) for the first set may be set to a first value, such as two, and the scrambling ID for the second set may be set to a second value, such as three.

According to another configuration, the physical layer distinction may be specified to define a set dependent rate matching offset. In still another configuration, the physical layer distinction may be specified to a delta value greater than zero to equation (1) for different enhanced control channel sets.

For example, the equation for resource set 1 may be equation (1). Furthermore, for the second resource set, the equation may be as follows:

Cᵢₙᵢₜ=(└nₛ/2┘+1)(2X+1)2¹⁶+n_{scid}+delta (2)

In another configuration, the first enhanced control channel resource set may use equation (1) and the second enhanced control channel resource set may use the following equation:

Cᵢₙᵢₜ=(└nₛ/2┘+2)(2X+1)2¹⁶+n_{scid} (3)

Still, the present configuration is not limited to physical layer distinctions, other physical layer distinctions are contemplated to distinguish the multiple enhanced control channel resource sets.

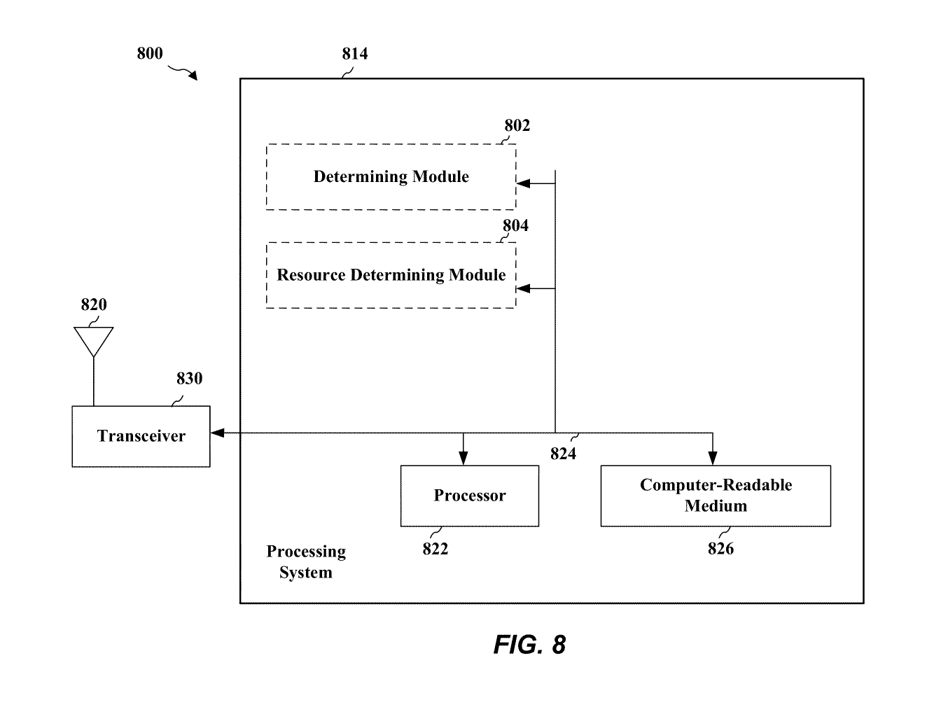

FIG. 8 is a diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822 the modules 802, 804 and the computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes a determining module 802 for determining whether decoding candidates for enhanced control channel resource sets overlap. The processing system 814 also includes a resource determining module 804 for determining uplink resources, such as ACK/NAK resources, based on a predefined rule when the decoding candidates overlap. The modules may be software modules running in the processor 822, resident/stored in the computer-readable medium 826, one or more hardware modules coupled to the processor 822, or some combination thereof. The processing system 814 may be a component of the UE 650 and may include the memory 676, and/or the controller/processor 675.

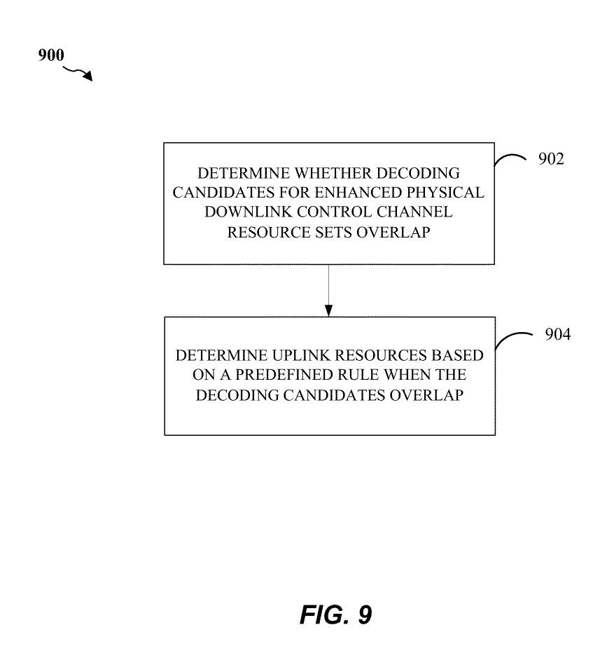

FIG. 9 illustrates a method 900 for determining uplink resources according to an aspect of the present disclosure. In block 902, a UE determines whether decoding candidates for enhanced control channel resource sets overlap. Each enhanced control channel resource set may be specifically configured for the UE. The enhanced control channel may be an enhanced physical downk control channel (EPDCCH).

Furthermore, in block 904, the UE also determines uplink resources based on a predefined rule when the decoding candidates overlap in block 904. In one configuration, the predefined rule indicates to use a decoding candidate association with a specific enhanced control channel resource set. In this configuration, the UE uses the decoding candidate associated with the first enhanced control channel resource set.

In one configuration, the uplink resources include uplink control channel resources for ACK/NAK transmission. The uplink resources may be determined based on a decoding candidate of a selected enhanced control channel resource set. The uplink resources may also be determined based on a number of an initial (or first) control channel element and/or an initial offset. In one configuration, the initial uplink offset is configured separately for each enhanced control channel resource set.

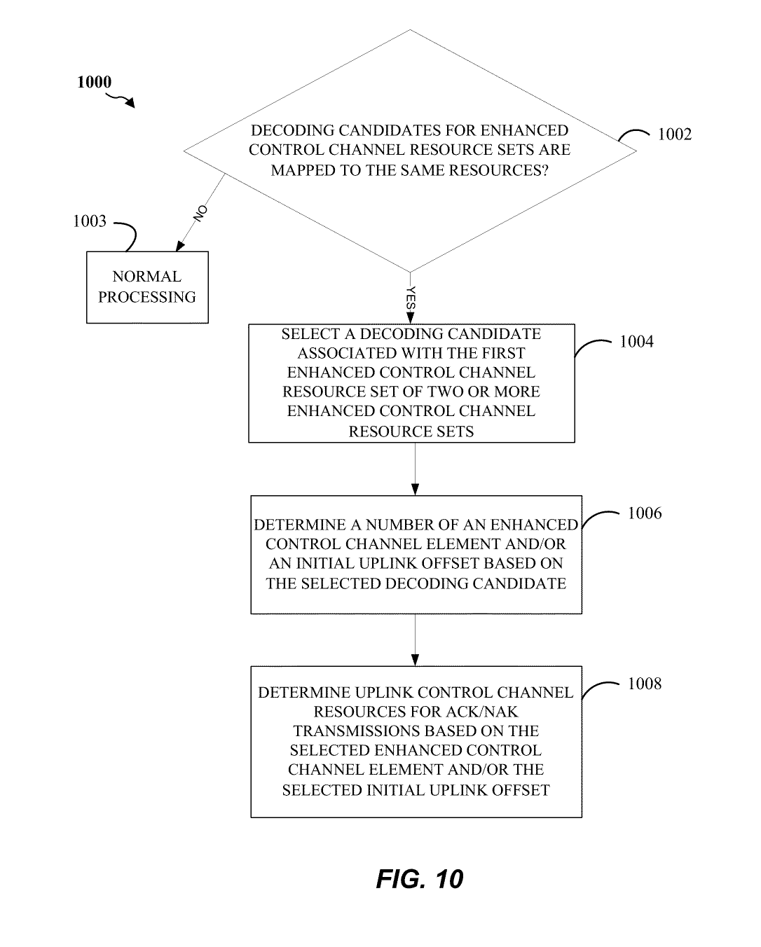

FIG. 10 illustrates a method 1000 for determining uplink resources according to an aspect of the present disclosure. In block 1002, a UE determines whether decoding candidates for enhanced control channel resource sets are mapped to the same resources. If different resources, normal processing occurs at block 1003. Otherwise, in block 1004, based on a predefined rule, the UE selects a decoding candidate associated with the first enhanced control channel resource set of the enhanced control channel resource sets. In block 1006, the UE determines a number of an enhanced control channel element based on the selected decoding candidate. Finally, in block 1008, the UE determines uplink control channel resources for ACK/NAK transmissions based on the selected enhanced control channel element.

Alternatively or in addition to determining the number of an enhanced control channel element, the UE may also determine an initial uplink offset based on the selected decoding candidate. Likewise, the uplink resources for the ACK/NAK transmission may also be based on the determined initial uplink offset.

In one configuration, the UE 650 is configured for wireless communication including means for determining. In one aspect, the determining means may be the controller/processor 659, memory 660; receive processor 656, modulators 654, antenna 652, and/or transmit processor 668 configured to perform the functions recited by the determining means. In another aspect, the aforementioned means may be any module or any apparatus configured to perform the functions recited by the aforementioned means.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber e (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
determining whether a plurality of decoding candidates for a plurality of enhanced control channel resource sets overlap; and
determining uplink resources based at least in part on a predefined rule when the plurality of decoding candidates overlap.

2. The method of claim 1, in which the predefined rule indicates one of the plurality of enhanced control channel resource sets associated with one of the plurality of decoding candidates.

3. The method of claim 2, in which the predefined rule indicates a first one of the plurality of enhanced control channel resource sets associated with one of the plurality of decoding candidates.

4. The method of claim 1, in which the plurality of enhanced control channel resource sets are configured specifically for a user equipment.

5. The method of claim 1, in which the uplink resources are further determined based at least in part on one or more of an initial enhanced control channel element (ECCE) index of an enhanced control channel decoding candidate, an initial uplink offset, or a combination thereof.

6. The method of claim 5, in which the initial uplink offset is configured separately for each of the plurality of enhanced control channel resource sets.

7. The method of claim 1, in which the uplink resources are uplink control channel resources for an acknowledgement/negative acknowledgement (ACK/NAK) transmission.

8. The method of claim 1, in which the uplink resources are determined for only a same downlink control information payload size.

9. The method of claim 1, in which the uplink resources are determined when a same virtual cell ID is configured for the plurality of enhanced control channel resource sets.

10. The method of claim 1, in which the plurality of decoding candidates are mapped to a same set of resource elements.

11. The method of claim 1, in which each of the plurality of enhanced control channel resource sets is configured with a localized transmission mode or a distributed transmission mode.

12. The method of claim 1, in which each of the plurality of enhanced control channel resource sets is associated with a user equipment specific search space or a common search space.

13. An apparatus for wireless communications, comprising:
a memory; and
at least one processor coupled to the memory, the at least one processor being configured:
to determine whether a plurality of decoding candidates for a plurality of enhanced control channel resource sets overlap; and
to determine uplink resources based at least in part on a predefined rule when the plurality of decoding candidates overlap.

14. The apparatus of claim 13, in which the predefined rule indicates one of the plurality of enhanced control channel resource sets associated with one of the plurality of decoding candidates.

15. The apparatus of claim 14, in which the predefined rule indicates a first one of the plurality of enhanced control channel resource sets associated with one of the plurality of decoding candidates.

16. The apparatus of claim 13, in which the plurality of enhanced control channel resource sets are configured specifically for a user equipment.

17. The apparatus of claim 13, in which the uplink resources are further determined based at least in part on one or more of an initial enhanced control channel element (ECCE) index of an enhanced control channel decoding candidate, an initial uplink offset, or a combination thereof.

18. The apparatus of claim 17, in which the initial uplink offset is configured separately for each of the plurality of enhanced control channel resource sets.

19. The apparatus of claim 13, in which the uplink resources are uplink control channel resources for an acknowledgement/negative acknowledgement (ACK/NAK) transmission.

20. The apparatus of claim 13, in which the at least one processor is further configured to determine the uplink resource for only a same downlink control information payload size.

21. The apparatus of claim 13, in which the at least one processor is further configured to determine the uplink resources when a same virtual cell ID is configured for the plurality of enhanced control channel resource sets.

22. The apparatus of claim 13, in which the plurality of decoding candidates are mapped to a same set of resource elements.

23. The apparatus of claim 13, in which each of the plurality of enhanced control channel resource sets is configured with a localized transmission mode or a distributed transmission mode.

24. The apparatus of claim 13, in which each of the plurality of enhanced control channel resource sets is associated with a user equipment specific search space or a common search space.

25. An apparatus for wireless communications, comprising:
means for determining whether a plurality of decoding candidates for a plurality of enhanced control channel resource sets overlap; and
means for determining uplink resources based at least in part on a predefined rule when the plurality of decoding candidates overlap.

26. A computer program product for wireless communications, the computer program product comprising:
a non-transitory computer-readable medium having program code recorded thereon, the program code comprising:
program code to determine whether a plurality of decoding candidates for a plurality of enhanced control channel resource sets overlap; and
program code to determine uplink resources based at least in part on a predefined rule when the plurality of decoding candidates overlap.
